(19) United States
(12) Patent Application Publication
(10) Pub. No.: US 2006/0163111 A1
(43) Pub. Date: Jul. 27, 2006

(54) Device holder apparatus

(76) Inventor: Daniel J. Baril, Hampton, NH (US)

Correspondence Address: Devine, Millimet & Branch, P.A., 111 Amherst Street, Manchester, NH, 03101, US

(21) Appl. No.: 11/020,767

(22) Filed: Dec. 23, 2004

(51) Int. Cl. B65D 69/00; A61H 1/00

(52) U.S. Cl. 206/569; 206/570; 601/2; 600/437; 600/15

(57) ABSTRACT

A device holder apparatus including a housing having a predetermined shape and size that accommodates the device. Also included is a flange attached to the housing. The flange has a surface attachment side which attaches to a surface.

### TECHNICAL FIELD

The present invention relates to a device holder apparatus.

### BACKGROUND INFORMATION

Devices are often required to be close to a surface in which the device is intended to effect, detect or otherwise interact. Many devices are portable. Devices include electronic devices and non-electronic devices. Examples of electronic devices are medical devices, time keeping devices, cell phones, PDAs, organizers, music devices such as MP3 player and portable personal stereos, as well as other devices known in the art.

To keep the device close to the surface, oftentimes a holder is used. A holder is any apparatus capable of holding something. A holder can hold the entire device or part of the device.

### SUMMARY OF THE INVENTION

In accordance with one aspect of the present invention, the invention includes a device holder apparatus including a housing having a predetermined shape and size that accommodates the device. Also included is a flange attached to the housing. The flange has a surface attachment side which attaches to a surface.

Some aspects of this embodiment may include one of more of the following: Where the flange further includes an adhesive on the surface attachment side; where the adhesive is a hydrogel adhesive; where the device holder includes a release liner at least partially covering the adhesive on the adhesive side of the flange; where the housing includes an open portion and a closed portion; where the flange includes a tab of a predetermined size and shape; where the housing further includes at least one opening having a predetermined size; and where the flange further includes a slit extending through the flange to the housing.

In accordance with another aspect of the present invention, the invention includes a device holder apparatus including a housing having a shape and size complementary to the device, the housing having an open portion and a closed portion. Also included is a flange attached to the housing, the flange having an adhesive side, the adhesive side being on the same side as the open portion of the housing.

Some aspects of this embodiment may include one of more of the following: where the device holder further includes at least one opening having a predetermined size; where the flange of the device holder further includes a slit extending through the flange to the housing; where the device holder further includes an adhesive on the adhesive side of the flange; where the flange includes a tab having a predetermined size and shape; and where the device holder further include a release liner, the release liner at least partially covers the adhesive on the adhesive side of the flange.

In accordance with another aspect of the present invention the invention includes a device holder kit. The kit includes a device holder and at least one coupling medium. Some aspects of this embodiment include one or more of the following: where the device holder includes a housing having a shape and size complementary to the device, the housing having an open portion and a closed portion, and a flange attached to the housing, the flange having an adhesive side, the adhesive side being on the same side as the open portion of the housing; where the device holder further includes at least one opening having a predetermined size; where the flange further includes a slit extending through the flange to the housing; where an adhesive is included on the adhesive side of the flange; where the flange further includes a tab having a predetermined size and shape; where the kit includes a release liner, the release liner at least partially covering the adhesive on the adhesive side of the flange; where the kit further includes a slip sheet; and where the coupling medium is at least one ultrasound gel pad.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description of preferred embodiments, taken together with the drawings wherein:

FIG. 1A is a pictorial view of one embodiment of the present invention;

FIG. 1B is an exploded pictorial view of the embodiment of the present invention shown in FIG. 1A;

FIG. 2A is a pictorial view of the embodiment shown in FIG. 1A with a device inside the housing;

FIG. 2B is an exploded pictorial view of the embodiment of the present invention shown in FIG. 2A;

FIG. 3A is a view of the embodiment shown in FIG. 2B with the addition of the slip sheet, making it one embodiment of the kit; and

FIG. 3B is a view of the embodiment shown in FIG. 3A with the addition of the coupling medium.

### DETAILED DESCRIPTION OF PREFERRED EMBODIMENTS

The invention is a holder for a device. In one exemplary embodiment, the device is a medical device. However, in other embodiments, the device is any device where the ability of the device to attach to a surface is desired. The device holder of the present invention holds the device and allows the device, while held, to be attached to any surface. The device is either held leaving the device directly interfacing with the surface (open housing) or else the housing is closed (closed housing) and the device does not touch the surface directly. Thus, in the open embodiment of the present invention, the device is held securely against a surface by the holder in such a way that the device itself is actually in direct contact with the surface (open portion of housing faces the surface).

In some embodiments, in addition to the opening, a coupling medium can be placed between the device and the surface. The device holder holds both the device and the coupling medium in place, against the surface. The coupling medium can be any substance and does not require adhesive characteristics, since the device holder will hold the coupling medium as well as the device against the surface.

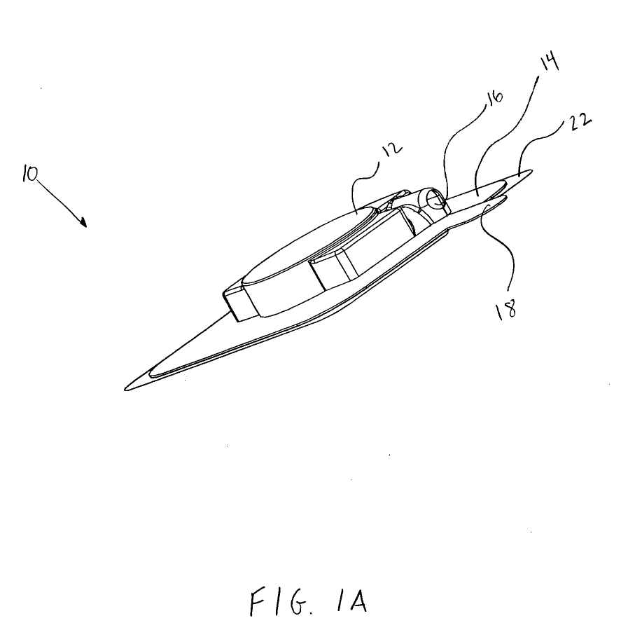

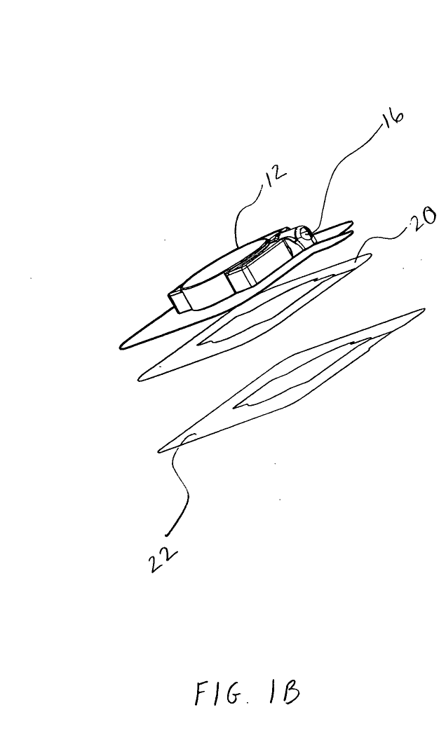

Referring first to FIG. 1A, one embodiment of the present invention is shown. The device holder 10 includes a housing 12 and a flange 14. As shown in FIG. 1A, the housing 12 is shaped to complement the device. Thus, in one embodiment of the present invention, the housing is molded into a shape that is complementary to the device it is intended to hold. The housing 12 can be made from a variety of materials. For example, a molded substrate, flexible film or foam or any other material capable of cupping or holding the device. However, in other embodiments, the device holder 10 is not molded, but rather, is made from any material having a stretchable characteristic and therefore, inherently will conform generally to the shape of the device once the device is inserted into the housing 12.

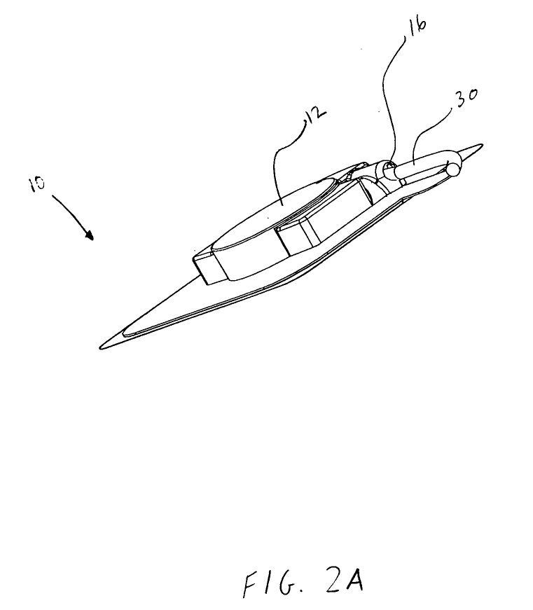

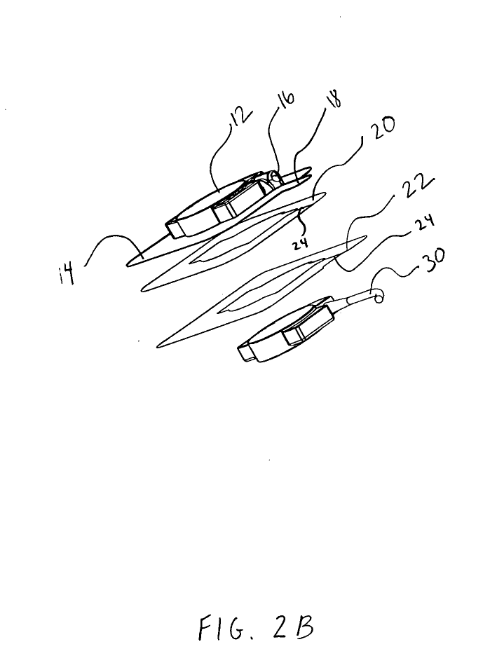

Referring now to FIG. 2A, the housing 12 cups the device so as to hold the device 30 in a stable manor. The dimensions of the housing 12 vary depending on the device in which it is intended to hold. Thus, although in the exemplary embodiment of the present invention, the housing 12 is shaped so as to complement and hold an ultrasound device 30, the invention is not limited to the ultrasound device 30, but to any device, independent of shape or utility.

Referring back to FIG. 1A, the device holder 10 includes a flange 14 surrounding the housing 12. The flange 14 can have any dimensions and the dimensions will vary depending on the device that the device holder 10 is designed to hold. The flange 14 allows the device holder 10 to be attached to a surface (not shown). In one embodiment, the flange 14 includes an adhesive on the bottom side (see 20, FIG. 1B). That is, the adhesive is on the attachment side of the device holder 10. In the exemplary embodiment, the housing 12 and the flange 14 are one molded part.

The invention is not limited to any type of adhesive. In the preferred embodiment, the adhesive is hydrogel. However, in other embodiments, and depending on the type of device and the type of surface in which the device holder will attach to, the adhesive varies. In alternate embodiments, the adhesive is acrylic or rubber based. The hydrogel is preferable for use with devices requiring repositioning on the surface. For example, in the exemplary embodiment, the device holder is shown to accommodate an ultrasound device. In this embodiment, the user of the ultrasound device likely will desire a device holder that attaches to the patient's skin and maintain its position and has the ability to change the position of the device on the patient's skin, and have the device holder maintain that new position. Therefore, in this embodiment, hydrogel is the most preferred adhesive. However, in other embodiments, other repositionable and non-repositionable adhesive systems such as acrylic or rubber-based are used depending on the application and device to be adhered.

In the preferred embodiment, the flange 14 includes a tab 18. In some embodiments where the flange 14 includes an adhesive, the tab 18 does not include the adhesive. However, in other embodiments, the tab 18 includes an adhesive or else includes a substrate to “kill” its adhesive properties. In some embodiments, the release liner covers the tab 18 with an adhesive and is cut so that the release liner can be removed from the adhesive on the flange separately from the adhesive on the tab. Among other functions, the tab 18 facilitates the removal of the device from the housing 12.

Still referring to FIG. 1A, some embodiments of the housing 12 include at least one opening 16 of a predetermined size to accommodate external elements of the device, or to allow for user interaction with the device. The embodiment shown in FIG. 1A shows one opening. In this embodiment, the opening accommodates a wire from the device. Referring to FIG. 2A, the wire from the ultrasound device 30 is shown emerging from the housing 12 through the opening 16. However, any element of any device can be accommodated by an opening 16. In some embodiments, the housing 12 includes multiple openings. The number of opening 16 is dependent on the type of device being held in the device holder 10. In some embodiments, the opening serves as a window to allow for manipulation of the device.

Referring back to FIG. 1A, in embodiments using an adhesive, a release liner 22 covers the adhesive so that the adhesive maintains its cleanliness and adhesion qualities before the device holder 10 is used. The release liner 22 can have any desired dimensions, however, in the preferred embodiment, the release liner 22 covers the adhesive completely and is of a complimentary shape to the adhesive. In the preferred embodiment, the release liner 22 is any substrate coated with silicone or a fluoropolymer treatment. However, in other embodiments, the substrate is coated with any other treatment known and used in the art.

Referring now to FIG. 2B, a slit 24 is included both in the adhesive 20 and the release liner 22. In some embodiments, the slit 24 is not included in either the release liner 22 or the adhesive 20, and in still other embodiments, the slit 24 is included in either the release liner 22 or the adhesive 20. The slit 24 extends from the tab 18 into the housing 12. In embodiments not including the tab 18, the slit extends from the outside of the flange 14 to the housing 12. In still other embodiments, the slit 24 is located anywhere on the flange 14. The slit 24 functions to reduce the peel force necessary to remove the device holder from the surface in which it is attached. The slit 24 additionally aids in the removal of the release liner 22 from the adhesive 20. Additionally, the slit 24 allows for better accommodation of wires and other external elements through the opening 16.

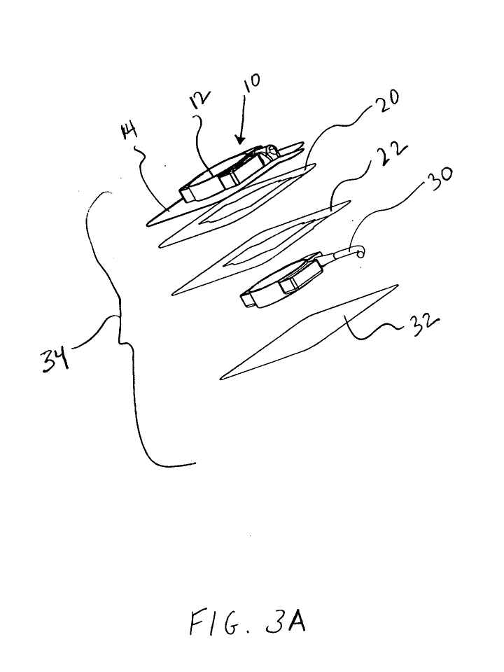

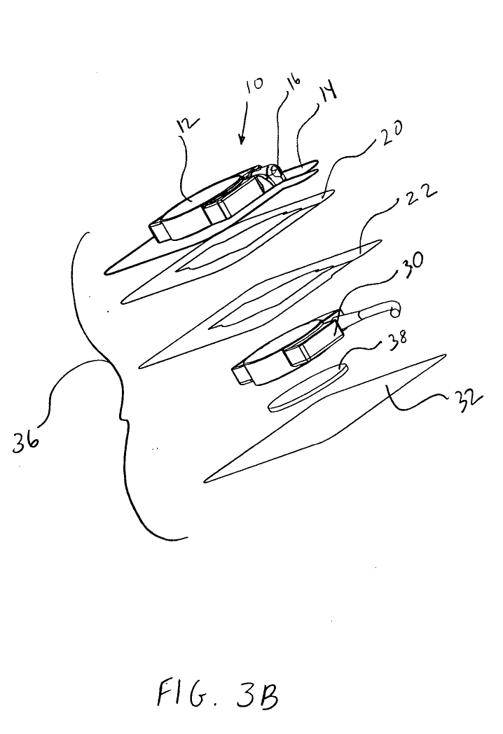

Referring next to FIGS. 3A and 3B, one preferred embodiment of the kit embodiment of the present invention is shown 34. The kit 34, 36 includes the device holder 10, including the housing 12 and the flange 14. In embodiments including an adhesive, the adhesive 20 is also included, as well as the release liner 22. Finally, in some embodiments, a slip sheet 32 is included. A device 30 is shown for illustration only, the device 30 is not included as part of the kit 34, 36.

Referring to FIGS. 3A and 3B, some embodiments of the present invention 34, 36 include a slip sheet 32. The slip sheet 32 can have any dimensions desired. The slip sheet 32 can be made from any material. In the preferred embodiment, the slip sheet 32 is slightly larger than the release liner 22 and is made of the same material as the release liner. When using an adhesive such as hydrogel, the adhesive has a tendency to migrate. The slip sheet 32 works to maintain the adhesive 20, specifically, to prevent the adhesive from migrating and affixing to the packaging for the device holder.

Referring to FIG. 3B, an embodiment of the kit 36 of the present invention is shown. In this embodiment, the kit 36 includes the device holder 10, including the housing 12 and the flange 14, the adhesive 20, the release liner 22, the slip sheet 32 and a coupling medium 38. The coupling medium 38 can be any coupling medium that complements the device being held by the device holder 10. In the exemplary embodiment, the device 30 is an ultrasound device, and the coupling medium 38 is an ultrasound gel pad. In other embodiments, more than one type of coupling medium 38 is included. In other exemplary embodiments, more than one ultrasound gel pad 38 is included.

Referring back to FIG. 1B, the device holder includes an adhesive 20 in some embodiments. However, in other embodiments, the device holder does not include an adhesive. In these embodiments, the device holder can be fastened to the surface by any means known in the art.

Although in the preferred embodiment of the present invention, the invention is molded to the shape of the device that it will hold, other embodiments do not employ this method. By molding the shape of the housing, the device holder provides the preferred hold of the device. However, this could also be accomplished by using a stretchable or other conformable substrate or the housing could be shaped in such a way that it holds a variety of different devices. Thus, the housing can be any generic shape.

The flange provides support for the adhesive. The flange can also be used to fasten the device holder to any surface, absent an adhesive. The flange can be any size to allow for a different amount of adhesive area available for attachment to the surface. In this way, any device of any weight or size can be held onto the surface.

Referring again to FIG. 3B, the exemplary embodiment of the present invention is shown. In this embodiment, an ultrasound device 30 is held by the device holder 10. The ultrasound device 30 is placed into the housing 12 of the device holder 10. A wire from the ultrasound device 30 is allowed through the opening 16. The release liner 22 is then removed from the adhesive 20, the ultrasound gel pad 38 is placed in the location desired, and the flange 14 is pressed onto the skin of a patient. Thus, the ultrasound device 30 is now touching the ultrasound gel pad 38, and the device holder 10 is maintaining the ultrasound device 30 and ultrasound gel pad 38 in the desired location on the patient's skin. In the preferred embodiment, the adhesive 20 is a hydrogel. However, when desired, the device holder 10 is pulled from the skin, and the device holder 10 is moved to a new location on the patient. The flange 14 is then pressed onto the skin, the hydrogel being reusable, securely fastens the ultrasound device 30 against the patient's skin in this second location. This can be repeated any number of times.

In other embodiments, the device is an insulin pump, a tocodynamometer, a fetal heart beat monitor, or any other medical device where it is desirable to maintain the device in a stable position, and at the same time, maintain the ability to move the device when desired. The present invention allows for attachment to either the skin or any other surface, and then remove and re-attach the device to another location. In still other embodiments, non-medical devices are used with the device holder. These include MP3 or other personal music players or personal stereos, cell phones, PDAs, blackberrys and any other device where the user desires the device to attach to a surface and/or their skin, and/or have the ability to remove the device when desired, and/or to change the location of the device easily.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A device holder apparatus comprising:
a housing having a predetermined shape and size whereby said housing accommodates said device having a predetermined shape and size; and
a flange attached to said housing, said flange having a surface attachment side whereby said surface attachment side attaches to a surface.

2. The device holder of claim 1 wherein said flange further comprising an adhesive on said surface attachment side.

3. The device holder of claim 2 wherein said adhesive is a hydrogel adhesive.

4. The device holder of claim 2 further comprising a release liner, said release liner at least partially covering said adhesive on said adhesive side of said flange.

5. The device holder of claim 1 wherein said housing further comprising an open portion and a closed portion.

6. The device holder of claim 1 wherein said flange further comprising a tab having a predetermined size and shape.

7. The device holder of claim 1 where said housing further comprising at least one opening having a predetermined size.

8. The device holder of claim 1 wherein said flange further comprising a slit extending through said flange to said housing.

9. A device holder apparatus comprising:
a housing having a shape and size complementary to said device, said housing having an open portion and a closed portion; and
a flange attached to said housing, said flange having an adhesive side, said adhesive side being on the same side as said open portion of said housing.

10. The device holder of claim 9 further comprising at least one opening having a predetermined size.

11. The device holder of claim 9 wherein said flange further comprising a slit extending through said flange to said housing.

12. The device holder of claim 9 further comprising an adhesive on said adhesive side of said flange.

13. The device holder of claim 9 wherein said flange further comprising a tab having a predetermined size and shape.

14. The device holder of claim 12 further comprising a release liner, said release liner at least partially covering said adhesive on said adhesive side of said flange.

15. A device holder kit, said kit comprising:
a device holder; and
at least one coupling medium.

16. The kit of claim 15 wherein said device holder comprising:
a housing having a shape and size complementary to said device, said housing having an open portion and a closed portion; and
a flange attached to said housing, said flange having an adhesive side, said adhesive side being on the same side as said open portion of said housing.

17. The kit of claim 16 wherein said device holder further comprising at least one opening having a predetermined size.

18. The kit of claim 16 wherein said flange further comprising a slit extending through said flange to said housing.

19. The kit of claim 16 further comprising an adhesive on said adhesive side of said flange.

20. The kit of claim 16 wherein said flange further comprising a tab having a predetermined size and shape.

21. The kit of claim 19 further comprising a release liner, said release liner at least partially covering said adhesive on said adhesive side of said flange.

22. The kit of claim 21 further comprising a slip sheet.

23. The kit of claim 22 wherein said coupling medium is at least one ultrasound gel pad.
